(19) United States
(12) Patent Application Publication
(10) Pub. No.: US 2008/0299961 A1
(43) Pub. Date: Dec. 4, 2008

(54) REMOTE/RADIO COMMUNICATION DEVICE

(75) Inventors: Volker Muller, Hilchenbach (DE); Jorg Peter, Siegen (DE)

Correspondence Address: PEARNE & GORDON LLP, 1801 EAST 9TH STREET, SUITE 1200, CLEVELAND, OH, 44114-3108, US

(73) Assignee: DOMETIC GMBH, Siegen (DE)

(21) Appl. No.: 11/776,247

(22) Filed: Jul. 11, 2007

(30) Foreign Application Priority Data
Jul. 13, 2006 (DE) 20 2006 010 816.5

(51) Int. Cl. H04M 3/00

(52) U.S. Cl. 455/419

(57) ABSTRACT

The invention describes a radio communication arrangement to be used especially in leisure facilities and to operate especially according to the ZigBee standard. In the area of motor vans, caravans, mobile homes or boats, secondary facilities, such as air conditioners, venting windows and lighting systems can be controlled with the arrangement. Likewise, sensor signals concerning the status of the battery charge, of a fresh water container or of alarm signals from smoke and movement detectors can be received and processed by the inventive installation by radio. Preferably, the signals can be put out or passed on over a cellular phone network to a cellular phone, in order to supply information directly to the user concerning his recreational vehicle.

The invention relates to a radio communication arrangement and, in particular to a radio communication arrangement, in which bidirectional communication can be carried between two or more communication partners according to a communication standard, which is based on a communication protocol.

In particular, one of the communication partners is designed, in this connection, as a command unit, the other communication partner being designed essentially as a receiving unit for commands from the communication unit and, as a unit, accepts the control commands and arranges for these control commands from the command unit to be carried out.

As technology develops further and advantageously priced semiconductor technology becomes available, the requirements for comfort during the operation and for automation rise continuously in the home sector as well as in the leisure sector.

Because cellular telephone technology or other media, such as the internet, are available from all sides, the user has become accustomed to have access everywhere to facilities and information, even if they are not directly available on the spot. For this reason, there is also a greater need in the leisure area to be informed of the current state of recreational vehicles and of the conditions there and, optionally, to issue commands by remote control and remote command, in order to set or check certain conditions in the recreational vehicles.

Various technical facilities, such as skylights, air conditioners, refrigerators, lighting fixtures, water pumps, awnings, heating systems, etc., the control of which necessitates a considerable expense for wiring, are already installed in the recreational vehicles of today.

Because the demands of comfort are rising steadily also in the leisure area, an expansion of technical facilities in the area of recreational vehicles should also be possible without great expense. In the case of devices of today, for which new equipment is to be brought into areas of a recreational vehicle, it is necessary to accommodate new control leads as well as electrical or other supply leads. This turns out to be particularly difficult, since recreational vehicles frequently are of light-weight construction and leads cannot simply be put in place without endangering the stability of the body of the recreational vehicle. Additional leads also increase the weight of the recreational vehicle and this has a negative effect on the registration and the driver's license classification.

The published German utility patent DE 202005015165 U1 discloses a remote controlled closing device for a vehicle. This closing device is to be compact and has a touch-sensitive display, with which different functions of the vehicle can be controlled and queried. For example, it is possible to query whether locks are open or closed, the liquid level in a tank, the state of charge of the battery and the location of a vehicle. It is also possible to use such facilities as an engine-independent air heating system or an air conditioner or an alarm system of the motor vehicle with the help of this remote control and to query or select corresponding information.

However, this prior art has the disadvantage that individual devices cannot be selected separately, that complicated wiring is required in order to distribute commands in the motor vehicle and to make information queriable over the radio device. It is likewise disadvantageous that a remote control of the associated facilities is possible only within the radio range of the key. Furthermore, with this device, it is not possible to set operating scenarios, which have to be adhered to as a consequence of certain surrounding conditions or certain parameters in the motor vehicle, or to query such parameters and, optionally to reset them.

Starting out from this state of the art, it is an object of the present invention to indicate a modular communication arrangement, which can be expanded easily and for which especially the possibility exists of setting, planning or controlling as a function of existing parameters complex operating scenarios of the different components of the communication arrangement.

The invention is to be usable particularly in recreational vehicles, such as caravans, motor vans, mobile homes and boats. In particular, at least the second communication devices of the communication arrangement should function in a particularly energy-saving manner.

Pursuant to the invention, this objective is accomplished by means of a radio communication arrangement of claim 1. Further developments of the invention are evident from the dependent claims 2 to 13.

Advantageously, an inventive communication arrangement consists of at least two devices. The first device is able to transmit and receive and the second device can, at least, transmit. A simple arrangement can be realized in this way, with which at least sensor data can be transmitted by radio from a second communication facility to a first facility, in order to be queried from there or processed further there.

Advantageously, for a further development of the inventive communication arrangement, detection means, with which it is possible to detect a parameter at the place of the second device, the second device having means for transmitting this parameter to the first device, are assigned to the second device.

It is particularly advantageous in a further development of the inventive communication arrangement that the second device has receiving means, with which it can receive commands from the first device, and implementing means, with which control commands from the first device can be brought to execution, so that, for example, actors can be actuated, the level of a liquid in a tank can be queried, etc.

Particularly advantageously, in a further development of the inventive communication arrangement, the second device is connected with a control device, so that the second device can be configured universally and connected with a different control device, as required.

In a further development of the inventive communication arrangement, it is particularly advantageous that the implementing means are assigned to facilities such as a refrigerator, air conditioner, lighting fixtures, awning, escalator, water pump, heating system or sky light, since these are facilities, which are encountered frequently in recreational vehicles, so that there is a great need in the market for cost-effective solutions, which can be realized easily and which can be made available by the invention.

Particularly advantageously, a further development of the inventive radio communication arrangement has means for carrying out a coded communication according, to a standardized radio communication protocol, such as the ZigBee standard because in this way, in view of the international operation, supraregional technical prerequisites are fulfilled, which do not require a renewed registration. Because recreational vehicles frequently may be moved across national boundaries, it is advantageous not to have to expect difficulties when the facilities are operated in a foreign country.

Particularly advantageously, for a further development of the inventive communication arrangement, the first device has a display for indicating at least one information relating to a second device, since a user of the communication arrangement can easily obtain the information he requires in this way centrally over connected second communication devices. Such information may relate, for example, to the time of day, the inside and outside temperature, the fresh water and wastewater level status, the status of the onboard battery, the status of gas cylinder, the power supply, etc.

It is particularly advantageous if the first device, in a further development of the inventive radio communication arrangement, has an input element, with which an input can be brought about, which generates a first radio signal, which is transmitted to a second communication device.

Particularly advantageously, a different further development of the inventive communication arrangement sees to it that the first device has means, with which it can communicate over a radio communications network, such as the cellular network GSM. In this way, the facilities in the recreational vehicle, which can be reached over the first device, can be controlled remotely, easily and cost effectively over the cellular network.

Furthermore, parameters, which are present at the place of the recreational vehicle and are queried, can be transmitted to the radio communications network and indicated over the cellular network, for example, on a cellular phone. For example, a user, particularly advantageously, can obtain information over his cellular phone when the battery in the recreational vehicle needs to be re-charged, an alarm is triggered, a smoke alarm is ringing or particular storage containers for gas and fresh water are empty, or when the battery charge has dropped below a specified value.

There is also the possibility to transmit commands with the cellular phone over the radio communication network to the recreational vehicle, so that, for example, the roof hatch can be opened, the light switched on and a heater or air-conditioner activated. Likewise, the refrigerator can be switched on by remote control, so that it will be at a pleasant cooling temperature when the owner of the recreational vehicle arrives.

Pursuant to a particularly advantageous further development of the inventive radio communication arrangement, commands can be sent over a cellular phone by means of SMS, that is, a short message can be transmitted to the first communication device, because this is standardized communication technology, which is already widely established and available reliably and cost effectively.

In the case of a further development of the inventive radio communication arrangement, it is particularly advantageous that, in the first device, action means are disposed, with which different actions can be controlled in the second devices, preferably over a timed control, but also as a function of sensor information, which is received from the second communication means and optionally is processed. For example, the light may be switched on at a certain time during the day and the TV or the radio may be turned on, so as to give the appearance that the recreational vehicle is occupied.

In the following, examples of the invention are explained in greater detail by means of the Figures, of which

FIG. 1 shows an example of a conventional control cabinet of a recreational vehicle,

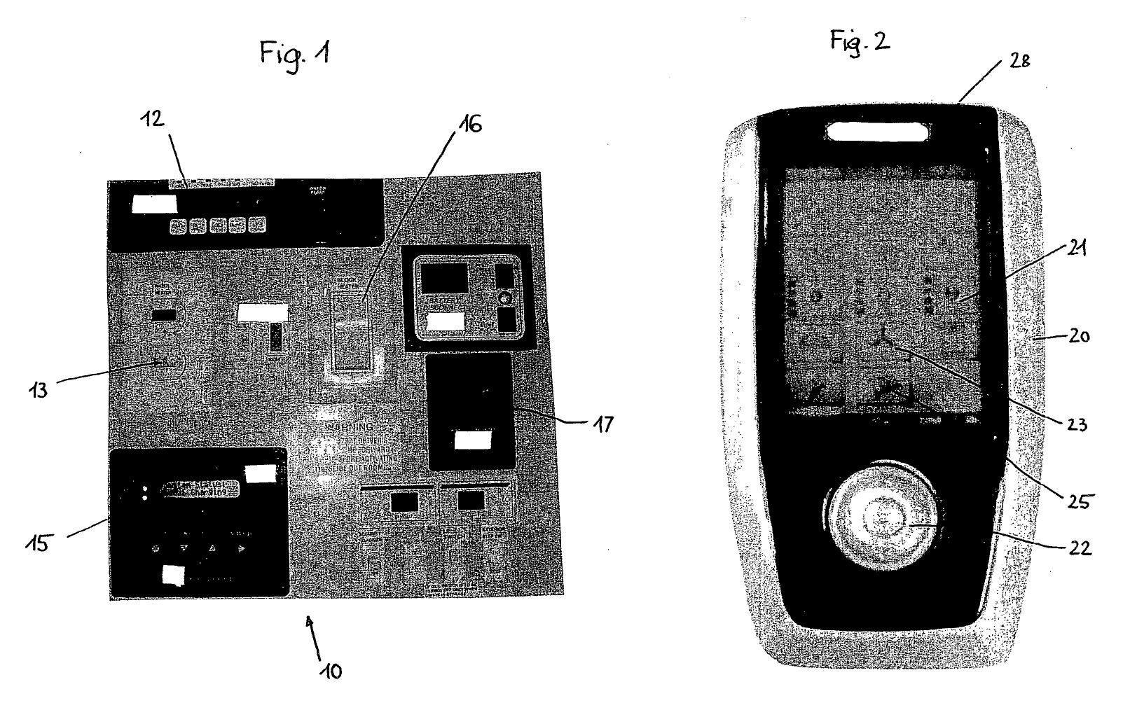

FIG. 2 shows an example of a first device of an inventive radio communication arrangement,

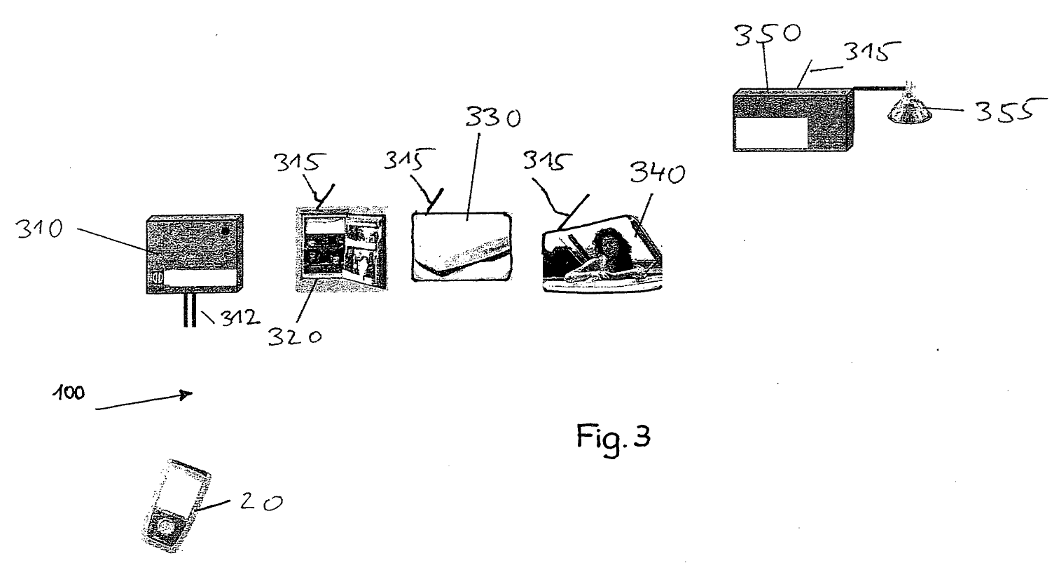

FIG. 3 shows an example of an inventive radio communication arrangement,

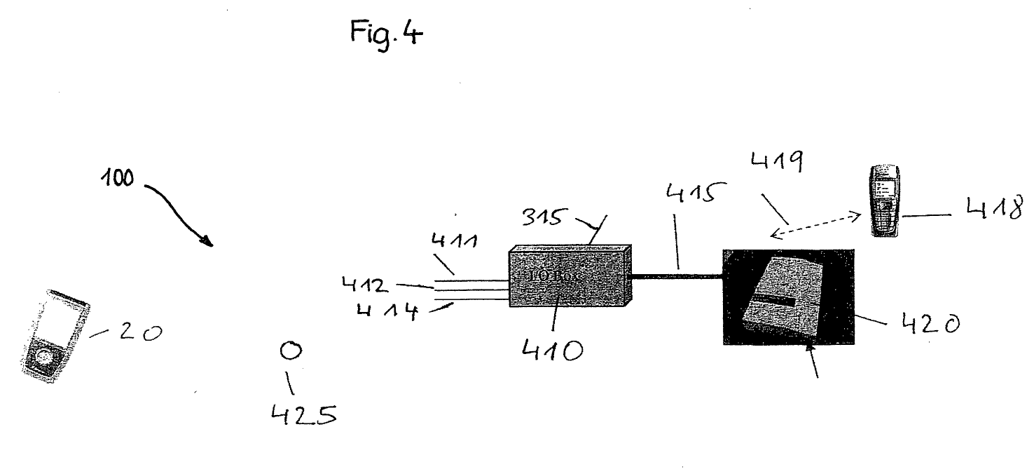

FIG. 4 shows a further example of an inventive radio communication arrangement,

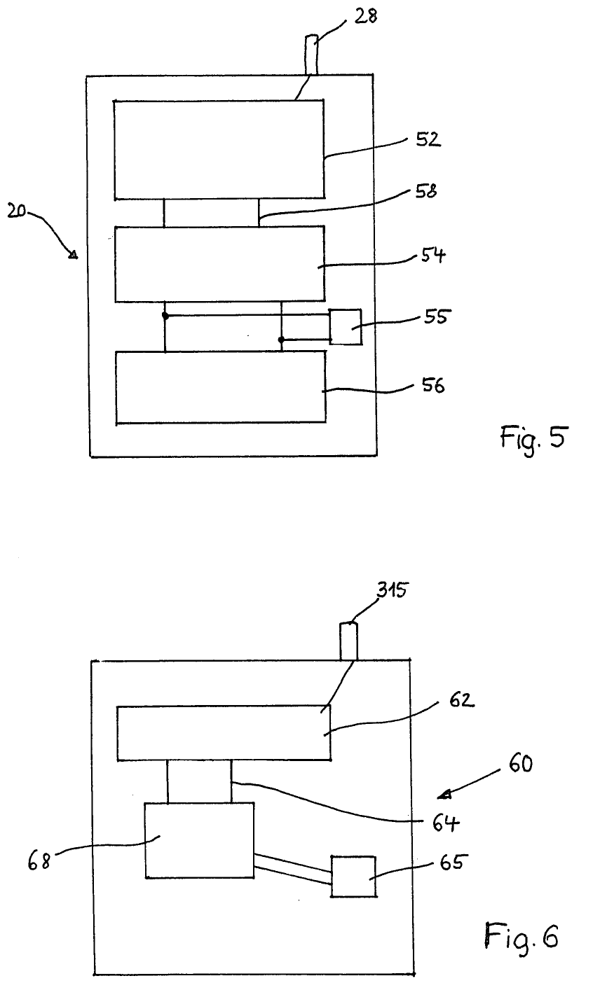

FIG. 5 diagrammatically shows the configuration of a first device and

FIG. 6 diagrammatically shows the configuration of a second device.

As shown in FIG. 1, a conventional control cabinet of a recreational vehicle has various switching facilities, such as fuses 12, a main light switch 13, a heater control 15, an onboard network switch 17 and a main switch 16. The control cabinet itself is labeled 10.

In conjunction with the inventive communication arrangement, this is discussed mainly in connection with recreational vehicles, such as boats, caravans or mobile campers, which are available on the market. There are, however, also areas in the house, in which the invention may also be used. For example, such areas of application are conceivable in the area of garden pavilions, boat houses and the like.

As can furthermore be seen in FIG. 1, switching facilities of various types occupy much space in recreational vehicles and are very intricate and not attractive in appearance. It can also easily be seen that the arrangement does not appear to have been planned and it is possible that it varies from device to device, so that it does not give the impression of being of high quality.

FIG. 2 shows a first device of an inventive communication arrangement. A display, with elements 21, 23 and 25, can be recognized clearly at the first device, which is constructed here, for example, as a bidirectional remote control. An antenna 28 is integrated in the device and a control facility 22 is mounted at the device. The first device itself is labeled 20.

Preferably, the inventive communication arrangement functions according to the ZigBee standard. ZigBee is an alliance of several radio hardware manufacturers, operating on the market, for cross-linking home devices. ZigBee enables household devices, sensors, etc. to be connected over short distances (10 to 75 m). It represents a protocol stack, which, according to the OSI model, loads PHY and MAC on the OSI sub-layers specified in the IEEE 802.15.4 standard.

The use of batteryless, maintenance-free radio switches and radio sensors in areas, where access is difficult, is also provided there, where the regular exchange of batteries is possible only at great expense (excerpt from Wikipedia of 5-12-2006). It can also be recognized clearly that the use of such a standard has advantages in the leisure area, where energy-saving facilities are absolutely essential.

Furthermore, the use of an international standard has the advantage that devices, based on the standard, are internationally compatible and that there are no problems when operating the device in foreign countries.

At 23, for example, a venting facility may be recognized. A refrigerator, an air conditioner, lighting fixtures, the awning, the motorized stairs of the mobile home, the water pump, the heating system and a roof hatch window can be controlled by means of the device 20.

Furthermore, the device, which works, for example with 12 V and a radio frequency of 2.4 GHz, can receive sensor information from a smoke alarm, from a measuring instrument for the vehicle battery, a measuring instrument at the gas cylinder, at the power supply system, etc., a thermometer for the inside and outside temperature, movement sensors, smoke sensors, rain sensors, performance sensors and switch positions of other devices, such as, for example, a lighting system, a fan, etc.

It is also conceivable to control a satellite receiving facility and a TV over the communication device 1.

FIG. 3 shows an example of an inventive communication arrangement 100. The first device 20 can be connected with second devices 320, 330, 340 and 350 by way of a radio. Moreover, the respective second communication devices have antennas 315. A refrigerator 320, an air-conditioner 330, a roof hatch 340 and in illumination switch receiver 350, to which an illumination device 355 is connected, are shown here by way of example. Furthermore, a charging station 310 is shown, which is supplied by the onboard network over leads 312 width 12 V DC voltage. The first communication device can be plugged into the charging station 312, in order to charge the battery located there.

Aside from the fact that the device 310 functions as a charging station, it may, in the plugged-in state, also exchange signals with the communication device 20 and, in the event that further communication devices are connected there, supply the communication device 20 with signals or control commands from these further devices or to pass control commands from the first device over leads to the second devices.

The second devices differ basically in their construction from one another owing to the fact that there are facilities, which only receive information and pass on sensor information concerning operating status and the status of the surroundings to the first communication device, so that they need not have a receiving facility, but only a transmitting facility and that there are second communication devices, which communicate bidirectionally, in that they receive commands from the first communication device and transmit signals concerning the operating status in their area to the first communication device, or carry out or pass on commands.

As shown in FIG. 4, a further example of an inventive communication arrangement comprises a communication box 410 with antenna 315 and a cellular phone communication module 420, which can communicate over a communication path 419 with a cellular phone 418. The input/output box 410 is connected over a communication path with the communication module 420. However, it may also be integrated directly in the module without affecting the mode of functioning of the inventive communication arrangement.

Furthermore, connecting leads 411, 412 and 414 are shown, with which the input/output box maybe connected, for example, with a sensor 425, which supplies status information of the recreational vehicle. Such sensors may be constructed, for example, as smoke detectors, rain detectors, motion detectors, fluid level indicators, dynamometers, GPS receivers, etc.

Signals and commands may be sent over the cellular phone 418, for example, by SMS or by DTMF signal transmission. These are then transferred to the input/output box and optionally query the sensors, which are connected to the leads 411, 412 and 414 or second devices connected over the radio link by way of the antenna 315. For example, the status of a roof hatch (whether open or closed) or the set temperature of an air-conditioner can be communicated. Optionally, a refrigerator can be switched on or off, lights can be controlled, an awning extended or retracted and/or the air-conditioner, the television or a radio device switched on. The input/output box can also control, for example, a water pump of the recreational vehicle by radio.

FIG. 5 shows, as an example, the diagrammatic construction of a first device of an inventive communication arrangement. The device is labeled 20. Basically, it can be stated that the first device may be the input/output box 410 as well as a hand-held remote-control device 20. In one case, it has input facilities and a display and, in a different case, it has communication means, with which it can communicate over the cellular phone network with a cellular phone. In principle, an antenna 28 is shown, over which a sending and receiving signal can be exchanged.

A sending and receiving facility is labeled 52, an internal wiring bus 58, a central processing unit 54, and an input/output facility 55, which may, for example, be a serial interface, which, in one case may, for example, be connected to a cellular phone communication module or, in a different case to a display and an input device. A memory is labeled 56. In principle, all the means, described in the invention, can be realized with the central processing unit and the memory, in that programs, stored in the memory 56, are implemented over the central processing facility.

In particular, operating scenarios, with which the presence of a user in the area of the recreational vehicle can be stimulated, can be filed in the memory. For example, blinds can be opened and closed, a roof hatch can be opened and lights can be switched on and off, as can a radio or a TV. Likewise, the air-conditioner and further facilities can be controlled on a timed basis.

There is also the possibility of setting certain scenarios in that, for example, when a signal is sent by the rain detector, a water pump is switched on and the roof hatch is closed or that an alarm is sounded when a smoke detector or a movement detector sends a signal.

FIG. 6 shows, as an example, the construction of the second device of the inventive communication arrangement. An antenna 315 for sending at least one signal, a transmitting facility 62, which may optionally be constructed as a transmitting/receiving facility, a controller 68 and an input/output device 65 are shown. The second device itself is labeled 60. In the simplest case, the second device 60 is connected over the input/output interface with a sensor and passes on the signals over the transmitting device 62 and over the antenna 315 to the first device, where the signal than is evaluated and processed.

In a different case, the second device has a sending/receiving facility and setting facilities and can, for example, transmit information concerning operational states to the first device, and at the same time, receive and execute commands from the first device.

Only examples of the invention are described above. They are intended to illustrate details of the invention without limiting it.

1. radio communication arrangement (100) with a first device and a second device, the first device (20, 410) having first means (28, 315) for transmitting a first command signal to the second device (320, 330, 340, 350) and with second means for receiving a second radio signal from the second device (320, 330, 340, 350); the second device (320, 330, 340, 350) having at least third means (315, 62) for transmitting the second radio signal.

2. The radio communication arrangement (100) of claim 1, for which a means (68) for detecting a parameter at the site of the second device is assigned to the second device (320, 330, 340, 350) and has means (55) for passing on the parameter to the third means (62).

3. The radio communication arrangement (100) of one of the preceding claims, for which the second device (320, 330, 340, 350) had a fourth means (62) for receiving the first radio command signal and implementation means (68), which are configured so that they arrange for the implementation of a control command contained in the first radio command signal.

4. The radio communication arrangement (100) of claim 1, for which the second device (320, 330, 340, 350) is connected with an input/output device (65).

5. The radio communication arrangement (100) of claim 3, for which the implementation means is assigned to at least one of the following facilities: refrigerator, air conditioner, lighting fixtures, awning, escalator, water pump, heating system and skylight.

6. The radio communication arrangement (100) of claim 3, for which fifth means (52, 62) for implementing the radio communication according to a coded standard protocol, especially a protocol compliant with the ZigBee standard, are present.

7. The radio communication arrangement (100) of claim 1, for which the first device (20, 410) has at least one display (21) for indicating at least one information (23) relating to the second device (330), and an input facility (22) for selecting the second device (330).

8. The radio communication arrangement (100) of claim 7, for which the input facility (22) is constructed so that a first radio command signal can be generated over an input.

9. The radio communication arrangement (100) of claim 6, for which the first device (410) has sixth means (56) for communicating directly or indirectly with a third device (420) of a cellular phone network, especially GSM.

10. The radio communication arrangement (100) of claim 9, for which the sixth means is configured so that a first radio command signal can be generated over it.

11. The radio communication arrangement (100) of claim 10, for which the sixth means is configured so that it conditions and/or passes on the second radio signal.

12. The radio communication arrangement (100) of claim 9, which is converted to conform to a short message standard, especially SMS.

13. The radio communication arrangement (100) of claim 9, for which seventh means are disposed in the first device (20, 410), which are configured so that they send at least a first radio signal as a result of receiving the second radio signal and/or on a timed basis.
